(19) United States
(12) Patent Application Publication
(10) Pub. No.: US 2006/0217066 A1
(43) Pub. Date: Sep. 28, 2006

(54) Wireless microphone system

(75) Inventors: William Giammaria JR., Escondido, CA (US); Jacqueline Mascitti, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/090,573

(22) Filed: Mar. 25, 2005

(51) Int. Cl. H04B 7/00

(52) U.S. Cl. 455/41.2

(57) ABSTRACT

A system may include a first device and a second device. The first device may receive analog speech signals, convert the analog speech signals to digital signals, and transmit the digital signals according to a Bluetooth communication protocol. The second device may receive the digital signals according to the Bluetooth communication protocol, convert the digital signals to loudspeaker-ready analog signals, and output the loudspeaker-ready analog signals.

### BACKGROUND

1. Field

Embodiments may relate to wireless communication devices. More particularly, some embodiments are concerned with reception, wireless transmission, and amplification of analog speech signals.

2. Description

Conventional wireless microphone systems may include a wireless microphone, a wireless receiver, an amplifier, and one or more loudspeakers. Such a system may be used in situations during which mobility of a user is desired. Examples of such situations include presentations, pop music concerts, and events requiring a master of ceremonies.

Wireless microphone systems provide several advantages over wired systems, but shortcomings remain. For example, wireless systems often use a proprietary transmission protocol. As a result, the hardware elements of a first system are often incompatible with hardware elements of another system. This incompatibility provides a manufacturer of the first system with a virtual monopoly over replacement hardware elements of the first system. Since a wireless receiver associated with the first system is most likely incompatible with wireless microphones of other systems, the manufacturer of the first system can charge a higher price for a replacement microphone than would be possible in the absence of the above-described incompatibilities.

The aforementioned incompatibilities may also prevent a user from using a same microphone at different venues. Specifically, a preferred microphone will only be usable in venues which provide a wireless microphone system that is compatible with the preferred microphone. To address the above and/or other issues, improvements in wireless microphone systems are desired.

### SUMMARY

According to some embodiments, a system includes a first device and a second device. The first device may receive analog speech signals, convert the analog speech signals to digital signals, and transmit the digital signals according to a Bluetooth communication protocol. The second device may receive the digital signals according to the Bluetooth communication protocol, convert the digital signals to loudspeaker-ready analog signals, and output the loudspeaker-ready analog signals. In some aspects, the second device includes a digital-to-analog converter to convert the digital signals to analog signals, and an amplifier to generate the loudspeaker-ready analog signals by amplifying the converted analog signals.

Some aspects of the foregoing further include a third device to receive second analog speech signals, to convert the second analog speech signals to second digital signals, and to transmit the second digital signals according to the Bluetooth communication protocol. The second device may receive the second digital signals according to the Bluetooth communication protocol, convert the second digital signals to second loudspeaker-ready analog signals, and output the second loudspeaker-ready analog signals.

Embodiments may also provide a system, method, program code and/or means to receive analog speech signals using a microphone, convert the analog speech signals to digital signals, transmit the digital signals according to a Bluetooth communication protocol, receive the digital signals according to the Bluetooth communication protocol, convert the digital signals to loudspeaker-ready analog signals, and output the loudspeaker-ready analog signals. Further aspects may include receipt of second analog speech signals using a second microphone, conversion of the second analog speech signals to second digital signals, transmission of the second digital signals according to the Bluetooth communication protocol, receipt of the second digital signals according to the Bluetooth communication protocol, conversion of the second digital signals to second loudspeaker-ready analog signals, and output of the second loudspeaker-ready analog signals.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram of a system according to some embodiments;

FIG. 2 is a flow diagram of a process according to some embodiments;

FIG. 3 is a representation of a system in a usage scenario according to some embodiments;

FIG. 4 is a block diagram of an input device according to some embodiments;

FIG. 5 is a block diagram of a communication protocol stack according to some embodiments;

FIG. 6 is a block diagram of a system according to some embodiments;

FIG. 7 is a block diagram of a system in a usage scenario according to some embodiments; and

FIG. 8 is a block diagram of a system in a usage scenario according to some embodiments.

### DETAILED DESCRIPTION

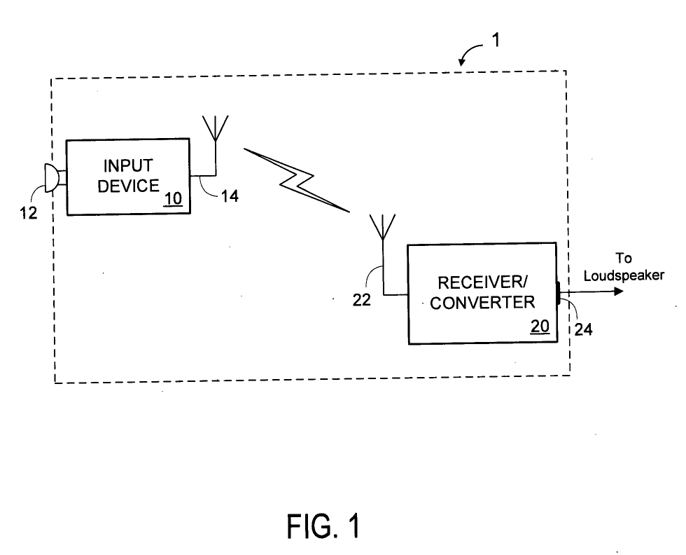

FIG. 1 is a block diagram of system 1 according to some embodiments. System 1 may receive analog speech signals using a microphone, convert the analog speech signals to digital signals, and transmit the digital signals according to a Bluetooth communication protocol. System 1 may also receive the digital signals according to the Bluetooth communication protocol, convert the digital signals to loudspeaker-ready analog signals, and output the loudspeaker-ready analog signals.

System 1 may comprise all or a portion of a wireless microphone system. As shown, system 1 comprises input device 10 and receiver/converter 20. Input device 10 comprises a wireless microphone according to some embodiments. Input device 10 may therefore include microphone 12 to receive analog speech signals and antenna 14 to transmit signals to receiver/converter 20 according to a Bluetooth communication protocol.

In some embodiments, receiver/converter 20 receives digital signals according to the Bluetooth communication protocol, converts the digital signals to loudspeaker-ready analog signals, and outputs the loudspeaker-ready analog signals. Antenna 22 of receiver/converter 20 may receive the digital signals according to a Bluetooth communication protocol and output interface 24 may output the loudspeaker-ready analog signals. The loudspeaker-ready analog signals may be output, as illustrated, to a loudspeaker.

Although microphone 12, antenna 14, antenna 22 and output interface 24 are illustrated as discrete elements, one or more of these elements may be implemented by any suitable arrangement that is or becomes known. For example, one or both of antenna 12 and antenna 22, may comprise an RF transceiver and antenna, an infrared port, and/or a USB port.

The Bluetooth communication protocol is maintained by the Bluetooth Special Interest Group. The Bluetooth communication protocol is evolving and some embodiments comply with at least one of past, present or future versions of the protocol. According to some versions, devices that comply with the Bluetooth communication protocol operate in the unlicensed, 2.4 GHz radio spectrum. These devices use a spread spectrum, frequency-hopping, full-duplex signal at up to 1600 hops/sec. The signal hops among seventy-nine frequencies at 1 MHz intervals in an attempt to provide substantial interference immunity.

Although the signal path between antenna 14 and antenna 22 appears to be direct, some embodiments may pass the signal through any number of intermediaries via any number of communication protocols in addition to the Bluetooth protocol. Such intermediaries include but are not limited to local area networks, wide area networks, telephone networks, cellular networks, fiber-optic networks, satellite networks, infra-red networks, radio frequency networks, and any other type of networks which may be used to transmit information between devices. Communication protocols that may be used in conjunction with some embodiments include but are not limited to Asynchronous Transfer Mode (ATM), Internet Protocol (IP), Hypertext Transfer Protocol (HTTP) and Wireless Application Protocol (WAP).

Moreover, although the illustrated communication link between the elements of system 1 appears dedicated, the link may be shared by other elements. Elements shown and described as coupled or in communication with each other need not be constantly exchanging data. Rather, communication may be established when necessary and severed at other times or always available but rarely used to transmit data.

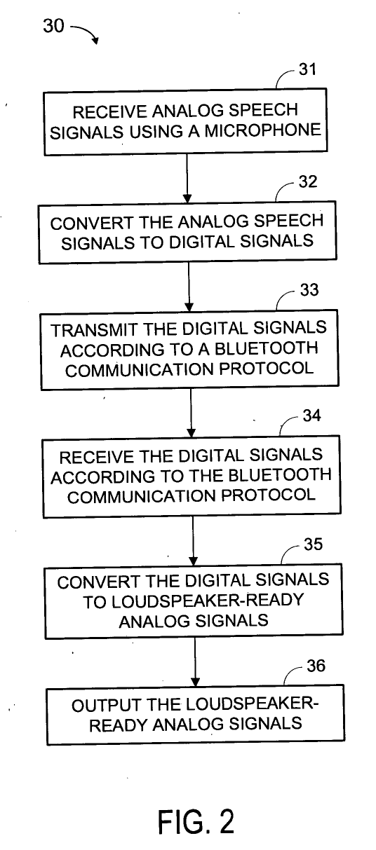

FIG. 2 is a flow diagram of process 30 according to some embodiments. Process 30 may be embodied in program code and/or executed by system 1 or other devices using any suitable hardware and/or software arrangement.

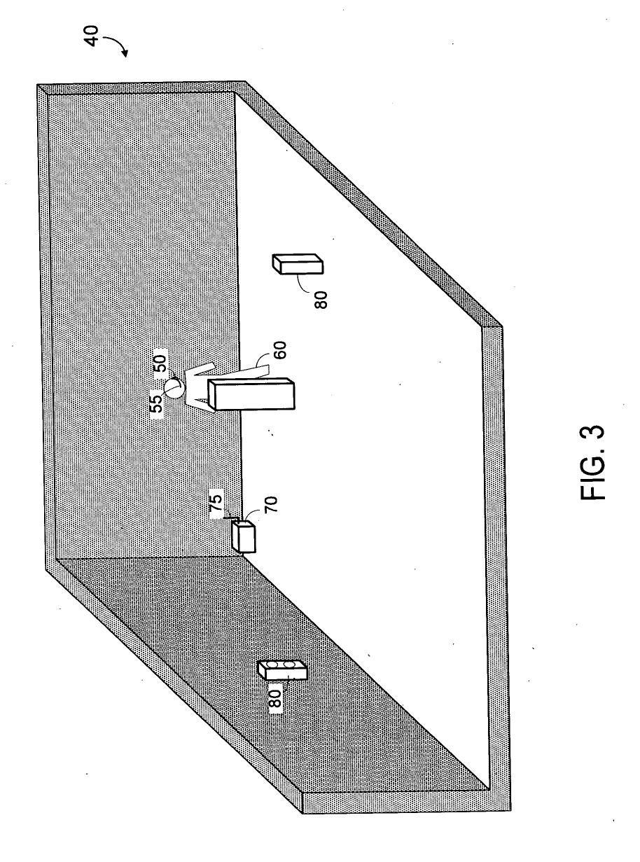

FIG. 3 illustrates environment 40 in which process 30 may be executed according to some embodiments. Environment 40 may comprise a room in which a presentation and/or meeting is to be held. As shown, the room includes input device 50, user 60, receiver/converter 70, and loudspeakers 80. Input device 50 and receiver/converter 70 may be implemented as described above with respect to input device 10 and receiver/converter 20 of FIG. 1, respectively.

According to process 30, analog speech signals are initially received at 31 using a microphone. The speech signals may be produced by the vocal structures of a user. Input device 50 includes microphone 55 that may be used at 31 to receive the analog speech signals from user 60 according to some embodiments.

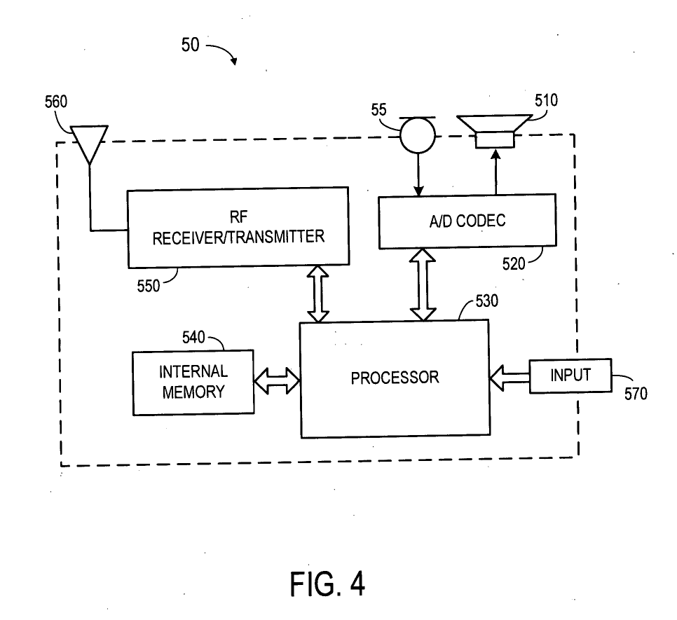

Next, at 32, the analog speech signals are converted to digital signals. Input device 50 may comprise hardware and/or software elements for converting the analog speech signals to digital signals. FIG. 4 comprises a block diagram of input device 50 for describing the conversion according to some embodiments.

Those in the art will understand that the block diagram of FIG. 4 is simplified in a number of ways. For example, the diagram omits all power and power management components of input device 50. Also, some embodiments may employ an internal architecture somewhat or completely different from that shown in FIG. 4.

Input device 50 of FIG. 4 includes microphone 55 and speaker 510. Analog/digital coder/decoder (A/D codec) 520 may receive analog speech signals from microphone 55, convert the analog signals to digital signals, and pass the digital signals to processor 530. Processor 530 may comprise a conventional microprocessor, microcontroller and/or digital signal processor (DSP) or other control circuit. In a case that input device 50 is being used as a two-way communication device, processor 530 may transmit digital signals to AID codec 520, which converts the digital signals to analog signals and passes the analog signals to speaker 510. Speaker 510 then emits sound based on the analog signals.

The converted digital signals are transmitted according to a Bluetooth communication protocol at 33. Continuing with the present example, processor 530 executes program code to format the digital signals and to control device 50 to transmit the formatted digital signals according to a Bluetooth communication protocol. Such program code may be stored in internal memory 540 of input device 50. Internal memory 540 may include one or more of ROM (read only memory), RAM (random access memory, e.g., static RAM), and flash memory. Memory 540 may also store program code that is executable by processor 530 to perform functions other than those that are described herein.

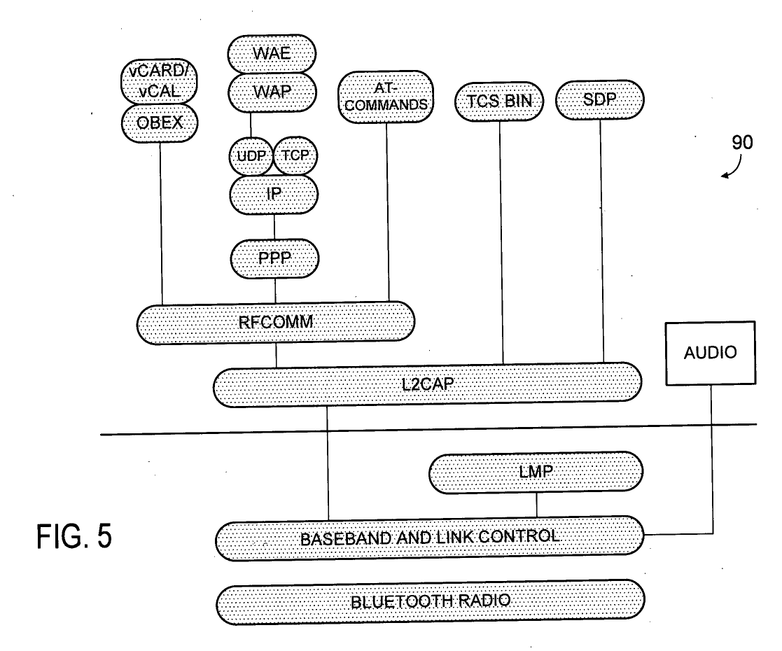

As mentioned above, some embodiments comply with one or more of past, current, and future Bluetooth communication protocols. FIG. 5 is a diagram illustrating Bluetooth protocol stack 90 according to version 1.0 of the Bluetooth Protocol Architecture (September 29,1999). In some embodiments of 33, processor 530 encapsulates digital signals received from A/D codec 520 according to the FIG. 5 protocol stack.

Protocol stack 90 enables applications to be written in compliance with a Bluetooth communication protocol and to consequently interoperate with one another. More specifically, matching applications (e.g., client and server application) in remote wireless devices are capable of interoperating with one another because they execute “over” identical protocol stacks. Different Bluetooth-compliant applications may execute over different protocol stacks. In this regard, a Bluetooth-compliant application may execute over one or more vertical slices of protocol stack 90.

Protocol stack 90 includes Bluetooth-specific protocols (e.g., Link Manager Protocol (LMP), Logic Link and Control Adaptation Protocol (L2CAP)) and non-Bluetooth protocols (e.g., Object Exchange Protocol, User Datagram Protocol). Protocols in addition to those shown may be accommodated on top of Bluetooth-specific transport protocols or on top of application-oriented protocols of stack 90. Application-oriented protocols are formed by protocols other than Service Discovery Protocol (SDP) that are located above Logic Link and Control Adaptation Protocol.

The Bluetooth core protocols LMP, SDP and Baseband and Link Control Layer may be employed in conjunction with some embodiments. The Baseband and Link Control Layer enables a physical Radio Frequency (RF) link between devices. The layer uses inquiry and paging procedures to synchronize transmission hopping frequencies and clocks of different Bluetooth devices. The layer provides Synchronous Connection-Oriented and Asynchronous Connectionless physical links. Synchronous Connection-Oriented packets may contain digital audio data. Audio data in Synchronous Connection-Oriented packets, as shown in FIG. 5, may be routed directly to and from the Baseband and Link Control Layer without going through the L2CAP.

The LMP is responsible for setting up a link between two Bluetooth devices. This setup may include authentication, encryption, and control and negotiation of baseband packet sizes. The LMP may also control power modes, duty cycles and connection states of a Bluetooth device.

The SDP provides discovery of accessible devices and services. In particular, the SDP allows query of device information, services and service characteristics. A connection between two Bluetooth devices can be established after executing queries supported by the SDP.

Returning to process 30, transmission of the digital signals at 33 also includes passing the digital signals to RF receiver/transmitter 550. RF receiver/transmitter 550 may provide further processing to encapsulate the digital systems according to a Bluetooth communication protocol. RF receiver/transmitter 550 may then transmit the digital signals via antenna 560.

The digital signals are received at 34 according to the Bluetooth communication protocol. Receiver/converter 70 may receive the signals in some embodiments. More specifically, the signals are received by antenna 75 of receiver/converter 70 at 34. Receiver/converter 70 may be located in any position that allows suitable reception by antenna 75 of the signals transmitted by device 50.

The digital signals are received in accordance with the Bluetooth communication protocol based on which the signals were transmitted at 33. Accordingly, the signals may be decapsulated based on the protocol stack that was used to encapsulate the signals prior to transmission.

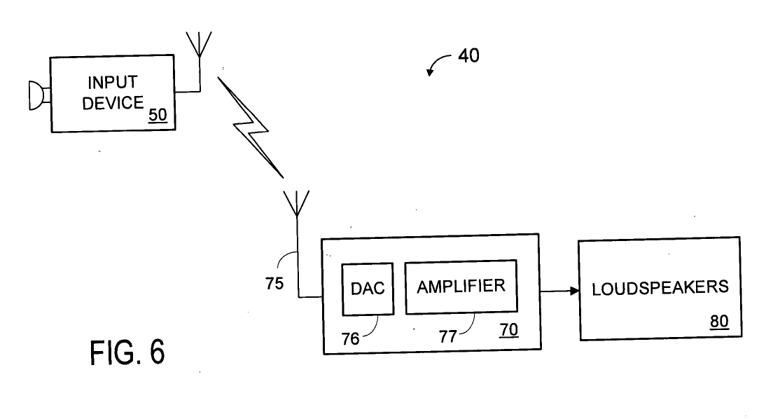

The digital signals are converted to loudspeaker-ready analog signals at 35. FIG. 6 is a block diagram of environment 40 according to some embodiments. As shown, receiver/converter 70 includes digital-to-analog converter (DAC) 76 for converting the received and decapsulated digital signals to analog signals. DAC 76 may perform some or all of the decapsulation according to some embodiments. In some embodiments, DAC 76 is a sub-band speech DAC particularly suited to decoding digital speech signals. Any other suitable DAC may be used to convert the digital signals to analog signals.

The converted analog signals may also be amplified to levels suitable for a loudspeaker at 35. Amplifier 77 may comprise any combination of hardware and/or software elements that is or becomes known and is capable of receiving signals of the type generated by DAC 76 and amplifying the signals to loudspeaker-ready amplitudes. Some embodiments of amplifier 77 receive line-level (˜750 mV) signals from DAC 76 and amplify the signals to speaker level (˜5V).

The loudspeaker-ready signals are output at 36. The signals may be output by an output stage of receiver/converter 70 that includes an output interface such as speaker wire terminals and/or other output jack. The signals may pass from the output stage to any equipment coupled to the terminals/output jack. FIG. 6 illustrates transmission of the output signals to loudspeakers 80.

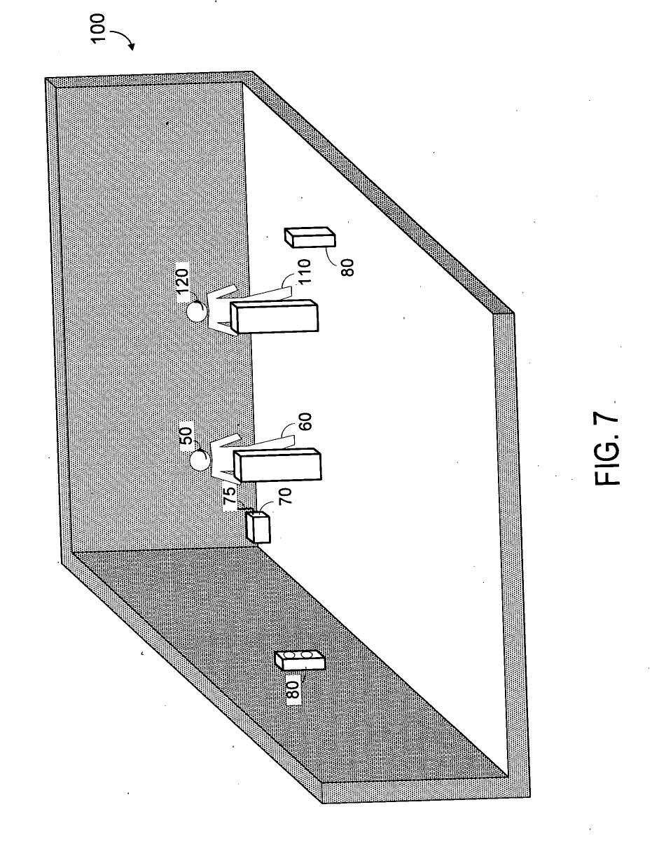

FIG. 7 illustrates environment 100 in which process 30 may be used. Environment 200 is similar to environment 40 but for the addition of user 110 and input device 120. Input device 120 may receive analog speech signals generated by user 90 and may convert and transmit the signals as described above with respect to stages 31 through 33 of process 30.

Therefore, receiver/converter 70 may receive a set of digital signals from input device 50 and a set of digital signals from input device 120 at 34. In this regard, some Bluetooth communication protocols allow the establishment and maintenance of up to seven simultaneous connections. Each set of digital signals may be separately decapsulated, converted to a set of analog signals and amplified by receiver/converter 70 as described in conjunction with stages 34 and 35.

Both sets of loudspeaker-ready analog signals may be output at 36. Such output may enable loudspeakers 80 to simultaneously reproduce speech generated by user 60 and user 110. According to some embodiments, receiver/converter 70 includes mixing, balance and tone controls to manipulate the output signals as desired.

In some embodiments, loudspeakers 80 are not directly coupled to receiver/converter 70. For example, the output signals may be output to a mixing console or to another signal-controlling device that passes the signals to loudspeakers. The signal-controlling device may apply additional amplification and/or signal processing to the output signals before passing the signals to the loudspeakers.

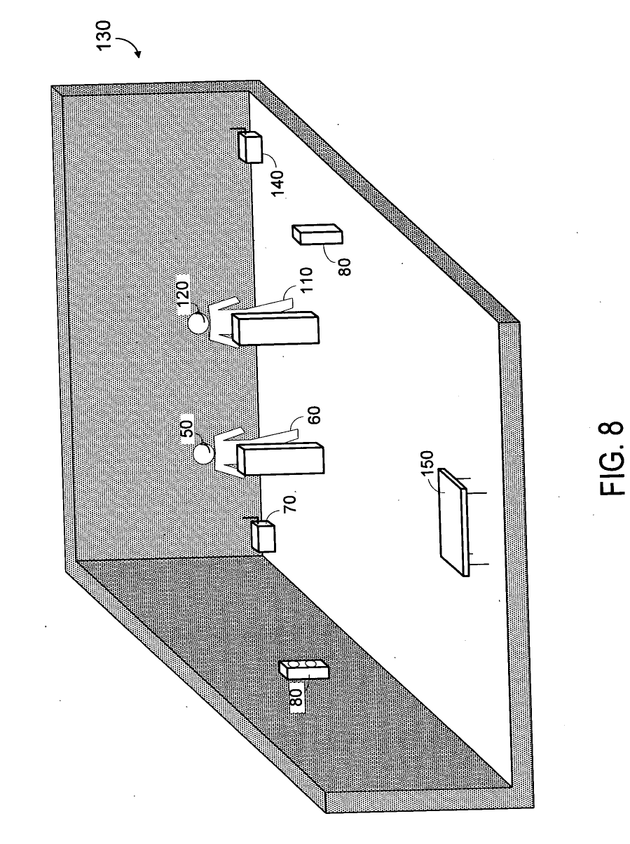

Environment 130 of FIG. 8 provides an example of the foregoing embodiments. Environment 130 adds receiver/converter 140 and mixing console 150 to environment 100. Unlike as described with respect to environment 100, receiver/converter 70 only acts upon signals received from input device 50. Accordingly, receiver/converter 140 acts only upon signals received from input device 120. Each receiver/converter outputs loudspeaker-ready signals to mixing console 150, which determines a mix of the signals to transmit to loudspeakers 80. Embodiments may implement scenarios other than those described herein.

The processes described above may be embodied as program code developed using an object-oriented language that allows the modeling of complex systems with modular objects to create abstractions that are representative of real world, physical objects and their interrelationships. However, embodiments may be implemented in many different ways using a wide range of programming techniques as well as general-purpose hardware systems or dedicated controllers. In addition, in some embodiments, many, if not all, of the elements described above are optional or can be combined into single elements.

Embodiments described above are not intended to be limited to the specific form set forth herein, but are intended to cover such alternatives, modifications and equivalents as can reasonably be included within the spirit and scope of the appended claims.

What is claimed is:

1. A system comprising:
a first device to receive analog speech signals, to convert the analog speech signals to digital signals, and to transmit the digital signals according to a Bluetooth communication protocol; and
a second device to receive the digital signals according to the Bluetooth communication protocol, to convert the digital signals to loudspeaker-ready analog signals, and to output the loudspeaker-ready analog signals.

2. A system according to claim 1, wherein the first device comprises a microphone to receive the analog speech signals.

3. A system according to claim 1, wherein the second device comprises:
a digital-to-analog converter to convert the digital signals to analog signals; and
an amplifier to generate the loudspeaker-ready analog signals by amplifying the converted analog signals.

4. A system according to claim 1, wherein the amplifier is to amplify the converted analog signals to line level.

5. A system according to claim 1, further comprising:
a third device to receive second analog speech signals, to convert the second analog speech signals to second digital signals, and to transmit the second digital signals according to the Bluetooth communication protocol, wherein the second device is to receive the second digital signals according to the Bluetooth communication protocol, to convert the second digital signals to second loudspeaker-ready analog signals, and to output the second loudspeaker-ready analog signals.

6. A method comprising:
receiving analog speech signals using a microphone;
converting the analog speech signals to digital signals;
transmitting the digital signals according to a Bluetooth communication protocol;
receiving the digital signals according to the Bluetooth communication protocol;
converting the digital signals to loudspeaker-ready analog signals; and
outputting the loudspeaker-ready analog signals.

7. A method according to claim 6, wherein converting the digital signals to loudspeaker-ready analog signals comprises:
converting the digital signals to analog signals; and
amplifying the converted analog signals.

8. A method according to claim 7, wherein amplifying the converted analog signals comprises amplifying the converted analog signals to line level.

9. A method according to claim 7, further comprising:
receiving second analog speech signals using a second microphone;
converting the second analog speech signals to second digital signals;
transmitting the second digital signals according to the Bluetooth communication protocol;
receiving the second digital signals according to the Bluetooth communication protocol;
converting the second digital signals to second loudspeaker-ready analog signals; and
outputting the second loudspeaker-ready analog signals.

10. A medium storing program code, the program code comprising:
code to receive analog speech signals using a microphone;
code to convert the analog speech signals to digital signals;
code to transmit the digital signals according to a Bluetooth communication protocol;
code to receive the digital signals according to the Bluetooth communication protocol;
code to convert the digital signals to loudspeaker-ready analog signals; and
code to output the loudspeaker-ready analog signals.

11. A medium according to claim 10, wherein the code to convert the digital signals to loudspeaker-ready analog signals comprises:
code to convert the digital signals to analog signals; and
code to amplify the converted analog signals.

12. A medium according to claim 10, wherein the code to amplify the converted analog signals comprises:
code to amplify the converted analog signals to line level.

13. A medium according to claim 10, further comprising:
code to receive second analog speech signals using a second microphone;
code to convert the second analog speech signals to second digital signals;
code to transmit the second digital signals according to the Bluetooth communication protocol;
code to receive the second digital signals according to the Bluetooth communication protocol;
code to convert the second digital signals to second loudspeaker-ready analog signals; and
code to output the second loudspeaker-ready analog signals.
